(19) United States
(12) Patent Application Publication
(10) Pub. No.: US 2019/0385112 A1
(43) Pub. Date: Dec. 19, 2019

(54) METHOD AND APPARATUS OF MATCHING CANDIDATE SUBSTITUTE TEACHERS TO CLIENT SCHOOLS

(71) Applicant: Aaron Copeland, Edgewater, MD (US)

(72) Inventor: Aaron Copeland, Edgewater, MD (US)

(73) Assignee: Rehab Plus, Inc. d/b/a alignstaffing, Washington, DC (US)

(21) Appl. No.: 16/433,201

(22) Filed: Jun. 6, 2019

Related U.S. Application Data
(60) Provisional application No. 62/685,622, filed on Jun. 15, 2018.

(51) Int. Cl. G06Q 10/06; G06Q 50/20

(52) U.S. Cl. CPC G06Q 10/063112; G06Q 50/20; G06Q 10/06315; G06Q 10/063116

(57) ABSTRACT

A method and apparatus for matching an available qualified candidate substitute teacher to a client school uses a rules-based mathematical algorithm to calculate a score for the candidate for matching with a degree of restrictiveness between one and three of a client school. The apparatus may comprise a mobile telecommunications device having a processor for receiving a special purpose computer application for providing at least one available qualified candidate at a predetermined start time, end time and duration during a school year. A search manager server may control a plurality of search engines for automatically verifying data initially received from one of a client school and a candidate. Once a match is made, a qualified candidate placed at a client school or a client school may periodically provide feedback to update a candidate client school database for the client school.

This application claims the benefit of the right of priority to U.S. Provisional Patent Application Ser. No. 62/685,622 filed Jun. 15, 2018, by the same inventor and incorporated by reference as to its entire contents.

### TECHNICAL FIELD

The present embodiments relate generally to an automated method and related apparatus for matching candidate substitute teachers to client schools for use by an employee staffing, organization and, more particularly, to a special purpose candidate/client school matching program and, for example, a related computer apparatus for use by candidates, typically having mobile devices, for uploading their background to a candidate/client school database for matching with requirements of client schools once the client school has submitted a job order request. Likewise, a special purpose client school, program and related apparatus assembles and verifies job order data and determines a tier level for candidate teachers. A server or search manager having a special purpose computer program, may be used by the staffing organization to verify input data and may comprise a mathematical model and rules for use by an employment agency to match qualified candidates as substitute teachers to a client school job order, the qualified candidate and client school providing feedback for modifying the mathematical model and rules to reduce the absenteeism rate of teachers in client schools.

### BACKGROUND

Qualified people of all ages, genders and races may find themselves in a position of desiring a substitute teaching position in a school proximate to, them. The client school may typically comprise students between the grade school levels of kindergarten (or pre-kindergarten including even toddlers) through high school. A substitute teaching candidate may be educated at least through four years of college or university and have a degree which may qualify them for a teaching position at a particular school, a private school or in a public school system.

Conventional matching of candidate employees with available positions may be represented, by the on-line methods used by an employee agency such as Robert Half® employment services. One may access their web site and be confronted as either a candidate employee or as a client employer offering temporary or permanent employment. A candidate “job seeker” is confronted with an introductory screen when the candidate visits the employment agency web site where the candidate is invited to utilize a drop-down menu to select an area of employment such as “technology.” In response to the inquiry, the employment agency system may perform a one-to-one correspondence between the technology menu choice of the candidate with twenty-five positions in the field of technology available for their selection.

Conventional input gathered from potential employers includes location data, rate or salary data and, in particular, a brief description of the temporary or permanent position available, for example, information technology help desk support engineer in Washington, DC at $20-27 per hour posted Jun. 6, 2018. More permanent positions in the technology field may be represented by a network engineer in Washington, DC at $75,000 to 95,000 per year posted Jun. 5, 2018.

Descriptive screen shots highlight a four-step process. Step 1 is for a client employer to describe their hiring needs i.e. simply describing the position data as outlined above “in minutes” on line or by simply calling them. Step 2 relates to the client's staffing options. The employment agency promises to provide from temporary to permanent skilled professionals. Step 3 relates to reviewing and selecting candidates. This involves, possibly, a one-to-one choice of qualified candidates, for example, in the technology field, by matching “technology” with candidates skilled in “technology.” The client selects from a presented pool of candidates or waits for more candidates to join the pool of candidates. Step 4 is allegedly the employment agency providing service to the client and ensuring their happiness with the agency.

A problem with the matching process of such an agency is that there is no definition of a category of employment such as “technology” and, of the twenty-five or so matches found of technology candidates, it would seem that the objective of the agency is to match as many possible candidates to such a broad field as technology without any specific automation that a general purpose computer could perform. The agency appears to employ, for example, a simple field matching in a database of candidates of those candidates with “technology” as a descriptor of their database field of interest. There would be a simple matching of “technology” with available positions. Rather than breed happiness between candidate and “technology” client, it is suggested that the typical employment agency process breeds dissatisfaction among candidates and clients alike by putting the burden on the candidate to make a selection of a possible position for them and on the client to determine if the candidate that selects the potential employer client matches the criteria set forth in the “technology” job description of, for example, “network engineer.” Again, “network engineer” appears to be aligned in a database with “technology” and consequently with a particular candidate interested in “technology.”

Because of the widespread use of such a matching process, the risks associated with its use are of increasing concern. In a recent study of absenteeism in schools across the United States, it was calculated that the average number of school days missed by teachers in permanent positions in schools was eleven days out of a shortened school year (for example, two hundred days, between September and May or June excluding school holidays.) Eleven days is a substantially large value when satisfied employees of other entities such as technical entities may have an absentee rate on the order of three or four days for a full year. It thus is an object of the present invention to reduce the number of absentees of teachers by providing, a set of rules and a mathematical model which more accurately matches the culture of the client school and candidate.

### SUMMARY OF THE PREFERRED EMBODIMENTS

AlignStaffing in Washington, DC has deviated from the typical process to the extent of identifying three categories for evaluating applicants for positions: appearance, intellect (articulation of experience and education) and presentation/personality. The somewhat subjective evaluation is performed by an intake recruiter during an interview where each category is rated from 1—good, 2—average and 3—not a good fit. The good and sometimes the average candidate may be placed with a school as a substitute teacher, for example. Client school information is submitted with the object of requesting a temporary placement of a substitute teacher based on the subjective evaluation of a candidate in the three categories via a job order.

Many anecdotal as well as recent studies support the hypothesis that a substitute teacher should not spend more than five days taking the place of a permanent teacher. There is a problem left to be solved that the substitute must adapt to the degree of restrictiveness of the client school and present themselves as a productive substitute, syllabus in hand, so that the substitute may indeed be a true substitute for the absent teacher, for example, for five days of absenteeism.

Methods and apparatus for matching substitute teachers for permanent teachers in client schools must begin with a client school application that may be used by a school administrator to input client school profile information with the object of automatically matching a job order or request with a qualified candidate. A candidate intake may include the completion of a candidate on-line application and a recruiter questionnaire via a back-end process. The gathering of data in a personal interview with the candidate may determine the quality level of the candidate. Each candidate may identify their experience and desires for teaching at a particular grade level from pre-kindergarten (infants or toddlers) to advance placement physics (high school) college level advanced placement course. A mathematical model and rules are provided matching client school input comprising a job order and school profile data with a score for the candidate. The candidate may be evaluated after the questionnaire/interview process at a level that is matched with the needs of a client school at the back end and a related tier level of the client school from least restrictive to most restrictive. To the above three categories, appearance, awareness and setting match have been added, a rating system developed and scores may be mathematically calculated for an applicant substitute teacher after a tier level is set for a client school.

Referring briefly to FIG. 1, there is shown a well-known Venn diagram in which the three inputs that are shown comprise a pool of candidates labeled kindergarten to second grade 120 which is a data collection process following a front-end process of collecting client school data and needs 110 at a front end which may be referred to herein as a job order. At prekindergarten level of elementary school, the teacher is encouraged typically to develop social skills between students and such artistic skills as elementary drawing and printing to handwriting skills. A goal by second grade may be reading, writing and basic arithmetic. Mathematically, the teacher may introduce numbers to students by second grade, and the teacher may introduce more complex topics such as long division and multiplication by second grade. The pool of candidates is represented in FIG. 1 by an exemplary oval 120 having interspersed solid bold and visible solid parallel lines pointing vertically from lower left to upper right. A pool of candidates for teaching what may be the most challenging course in a high school curriculum, advanced placement physics, is exemplified by the oval 130 at the lower left comprising dots.

These candidate ovals are but examples of breaking the candidate pool of substitute teachers into teaching ability levels while a cross-hatched oval represents a collection of client school job orders 110 which is the culmination of job order input through a front-end client device set of display screens requesting client school information per FIG. 6A-6J. FIG. 1 thus shows that matching of candidates to client school needs requires a complex overlapping of pools such that the overlapping regions, for example, result in an area taken from the client school pool and the candidate pool to limit the overlapping regions to represent a very small pool of qualified candidates for a given position (referred to herein as a job order). A search manager 220 of FIG. 2 will match a client school job order and its profile data to a select a set of candidates for a particular teaching position, for example, an advanced placement class teacher at a college level. The search manager preferably builds a set of candidate/client school databases 200 for each client school and verifies input data automatically via search engines 210(1) through 210(n).

FIG. 2 represents a diagram showing how the invention may be embodied in hardware. In the depicted example, client schools 230(1), 230(2) . . . 230(m) first input their requirements for a substitute teacher at a particular grade level and quality level by utilizing, for example, a computer processor software application that may run on a client hand-held device such as a cell phone and be used, for example, by a school administrator. The client school administrator may establish a unique user name and password for gaining status of their job order, to complete a job order or to check status of a job order after the job order is submitted. Also, the client school is asked for school profile data per input box 345 (FIG. 3). Typically, the requirements for a teaching position at a particular client school are closely related to educational background and experience at the level of teaching required by the client school. The school may be rated at a tier level from least restrictive to most restrictive in the cultural relationship among students and between teacher and student and school administrator. If the client school requires an athletics coach, then, experience may be requested by individual sport and the candidate's ability to teach the fundamentals as well as cohesiveness of team sports. The quality level of a client school herein is referred to as a Tier, and there may be three tiers, from least restrictive to most restrictive. The most restrictive tier may, for example, comprise a private school where uniforms are worn by the students, the teachers are expected to dress in coat and tie and should be excited about their teaching exhibiting a positive personality at all times (if possible) for example, be sanguine (represented by A) or phlegmatic (represented by D) as opposed to melancholic (B) or choleric (C). The lowest scoring candidate acceptable to a Tier 1 client school is 0.5, average restrictive Tier 2, a score of 1.0 and most restrictive Tier 3 a lowest score accepted of 3.0.

Continuing to refer to FIG. 2, there are shown a plurality of prospective candidates 205(1), 205(2) . . . 205(1) which follow an application process and are invited for an interview with a recruiter. Candidates may be evaluated by input through a hand-held device and an application set of screens or displays. Education, experience, location and maturity are requested of an applicant among other possible limitations such as drug use, medical handicaps or illnesses and criminal record. If the client school requires an athletics coach, then, experience may be requested by individual sport and their teaching the fundamentals as, well as cohesiveness of team sports. Conflict maturity is also judged at an interview of a potential candidate where there may be some subjective level of maturity in dealing with and handling student and peer conflicts. For example, a hypothetical situation may be introduced by a recruiter of a fight breaking out between a pair of students. Conflict maturity with students, peers and administrators is either graded as a Y for yes or N for no. The candidate either deals with hypotheticals in a positive way or does not exhibit conflict maturity. Presentation is graded at a personal interview and is regarded as an observation of talent of the candidate during interview interaction, for example, how have they presented themselves at the recruiter interview? If there appears to be an observation of talent of the candidate, the candidate begins with a score of 3. Further pluses are formal, familiar, pleasant presentation awarded +0.5, +1.0 and +1. If there are mitigating circumstances surrounding the candidate that, for example, more closely match the culture of a client school, then, a discretionary +1 may be further added. Detractors include a sense of forwardness (−0.5), being pushy (−0.5), the candidate exhibits a degree of having been inconvenienced by the interview (−2.0) or becomes agitated at the interview (−1.0).

In a set of applicant input display screens of a related downloadable candidate application (not shown), the candidate may input data of their experience, education, location and the like via a hand-held device with the plurality of display screens representing data input opportunities. This set of screen responses may be stored in a candidate database and the applicant identify themselves by a user id and a unique password in a similar manner as the client school. The hand-held device in either case may be most conveniently a cellular phone such as an i-phone or an Android operating system Samsung phone having global positioning capabilities, a camera and a calendar and real time clock for displaying and recording real time and date.

Similarly, an administrator of a client school may utilize a downloadable computer application resulting in a job order for a substitute teacher at a certain grade level or having a particular specialty such as a science, art, mathematical, English literature, language background (fluent in French) or other teaching or interpersonal ability skills. This application and submission of a job order may be followed by the use of a client school questionnaire for determining whether the client school appears to be least restrictive, average restrictive or most restrictive. The mathematical scores attributed to a candidate may then, be matched at the back end to a submitted job order to the tier level attributed to the school and the client school job order received on line so that a client school culture may not be mismatched to a choice of potential substitute teacher. For a particular school, one or more available qualified candidates may be automatically identified and contacted for an identified substitute teacher position.

Once a position is filled, both the candidate and the client school may be periodically requested to provide input as to how each is performing relative to their initial perceptions of one another. For example, a candidate may provide feedback that suggests that a client school is not as restrictive as the candidate originally thought. The client school may input data, for example, as to interpersonal skills of a candidate such as the candidates successfully resolving a conflict between two students.

A search manager 220 of FIG. 2 is responsible for verification of input received and stored in a set of candidate/client school databases 200 (one for each client, school) via search engines 210(1) through 210(1). These search engines are responsible for verifying data received from a candidate and from a client school. Search engine 210(1) may be responsible for verifying kindergarten or toddler teacher qualifications. Search engine 210(2) may be responsible for first grade and so on to qualifications for an advanced placement physics teacher. The search engines may be alternately defined in terms of type of data collected such as educational background, experience level, references, criminal background and medical history. For example, a candidate may provide educational background, experience background, medical background, admit or deny sale/purchase/use of an illegal substance or criminal activity, religion, ethnicity and other data that may be relevant to selection as a qualified candidate substitute teacher and be verifiable automatically by search engines 210 (FIG. 2). A client school may also provide data such as its relationship to other schools, a course syllabus, data as to sports and equipment provided for the students to play sports, the funding of classroom supplies and the like. Each of the plurality of search engines 210 may verify or discover some cause for concern regarding either a candidate or a client school at step 350 of FIG. 3 in building the set of AQC and client school databases 200 at 340. If significant deviations are found during the verification process of either candidate or client school, the candidate or client school may not be qualified as a successful result of AQC verification at step 360.

Further provided are methods of periodically providing feedback by the selected candidate and the client school so that candidate scoring and tier parameters for client schools may be modified for the rules/mathematical model 350 (FIG. 3) of the special purpose matching program and its follow-up forecasting features (FIGS. 3 and 4) to be discussed herein may result in a less stressed environment for a school teacher so that their absentee level may reduce from the expected and both the client school and the substitute teacher may feel comfortable and productive in their relationship and shared culture.

### BRIEF DESCRIPTION OF THE FIGURES

Embodiments of the invention are herein described, by way of non-limiting example, with reference to the following accompanying Figures:

FIG. 1 is a well-known Venn diagram intended to exemplify a matching process of a pool of varying candidates (from toddler/infant age teaching positions) to a need for an advanced placement physics instructor entered by a client school job order downloaded via a client hand-held device such as a cell phone by a school administrator at a client school, the client school having a varying degree of restrictiveness;

FIG. 2 is a schematic block diagram of the hardware relationships between a plurality of candidates, a plurality of client schools and a plurality of search engines for each level of candidate and grade/course of client school for utilizing rules and mathematical models as described herein for accomplishing a match between a qualified candidate and a client school wherein a search manager server 220 may build a set of candidate/client school databases 200 and verify data input into the databases via a plurality of search engines, for example, for verifying candidate input such as experience level, education, medical history, location, criminal record and prior use of drugs (yes or no) and the like or client school profile data;

FIG. 3 is an exemplary flowchart showing an available qualified candidate (AQC) process used as a predictor at the client school level (pre-school, elementary, middle or high school) to determine the forecasted quantity/potential of talent needed during a school year. The output of the process is not only a quantity for, for example, a given month of AQC's but the output can predict job orders and provide a pool of qualified AQC's at the given teaching level (see FIG. 4) on, for example, a weekly basis and so whether the recruiter(s) should step up recruiting efforts at a given school level, or no additional talent is needed at this time (a Christmas or spring break). The flowchart of FIG. 3 shows input and dialog, with a potential applicant after receiving client school data at its level and job order data, the recruiter interview process, forming a database of AQC data and client school data and using a mathematical model and rules to build an AQC/client database and have a Rules/Mathematical model assist in periodically predicting AQC results, for example, on a weekly basis for at least a month during a school year at each level of school, from pre-school (infants and toddlers) to high school and the number of aides required as requested as well by the client school.

FIG. 4 is an exemplary chart for the month 405 of July, 2018 of certain AQC results of prediction for the month. Weighted performance 410 is the percent of activity in a given month. SMRT Talent Placed 415 is a number of substitute teacher or aide placements on each given day in July. A Pool Placement Goal 420 may be 90% of the Job Orders received from a client school or set of client schools. It is estimated that each temp (substitute AQC teacher) will have two to three job orders (JO's) each week. Also, we expect a 60% Fall-off rate from week to week by the client school. The Replacement target is, for example, twelve Temps per week placed. Job Orders (JO's) 430 are the orders coming in from the client schools at all levels. We expect a 90% fulfillment rate of all JO's from the AQC pool of talent. Finally, Pool Size 435 may be the estimated number of candidates available for placement at the end of each week. A monthly, summary for July is shown as data 450.

FIGS. 5A and 5B are examples of typical servers for making matches, predicting needs for AQC's, maintaining a database of client schools, scoring candidates and the like and is related to a flowchart (FIG. 3) for providing forecasts and incorporating feedback to recruiters by candidates and business consultants by client schools and feedback data that may be input as changes in parameters to the rules/mathematical model 355 of FIG. 3.

Exemplary screen shots are shown in FIG. 6A through 6J for a client school administrator to initiate a job order through an automated SMrt process of a mobile device, downloaded software application to fill a substitute teacher or aide need (job order) with an available qualified candidate (AQC).

These and other features of the present method and apparatus for matching substitute candidate teachers (AQC's) to client schools will be described in the DETAILED DESCRIPTION which follows.

### DETAILED DESCRIPTION

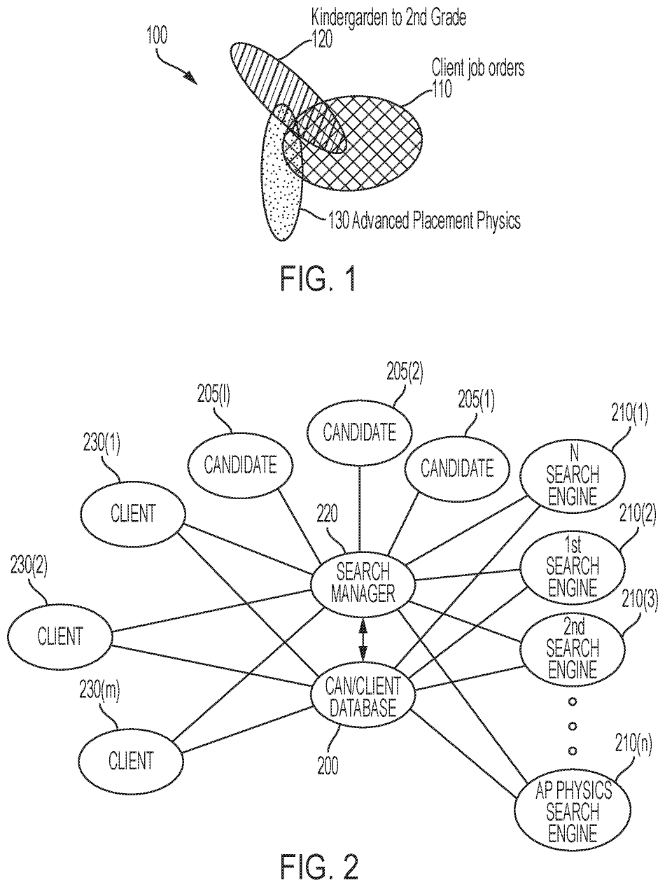

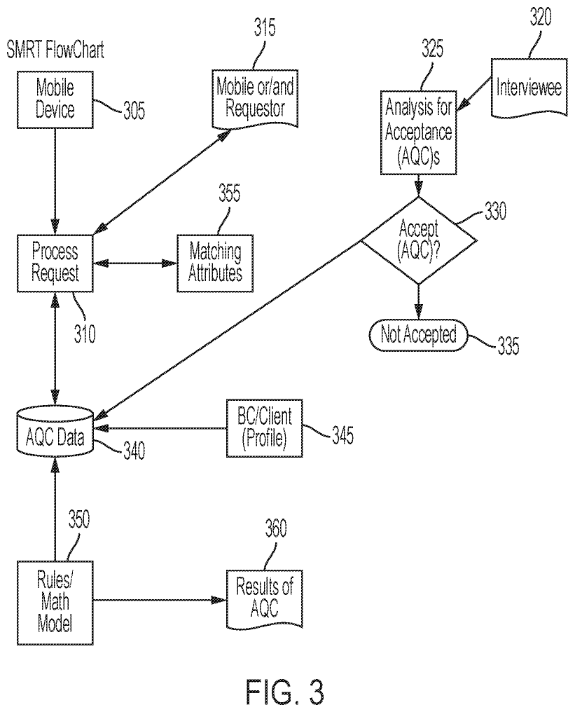

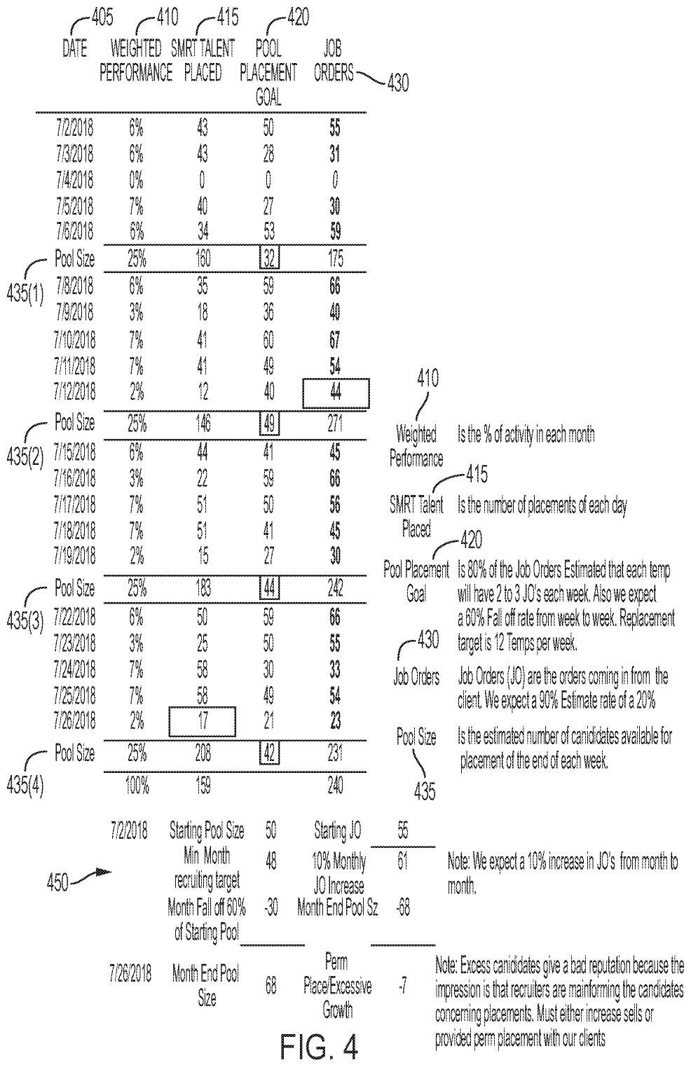

Generally provided herein are various methods and systems of apparatus for use by candidate substitute teachers, recruiters and business consultants of an employment agency and by client schools to provide quantitative and qualitative AQC results that may provide a set of AQC/client, school databases 200 under control of search manager server 220. The server may be a predictor of AQC requirements over a period of time (FIGS. 3 and 4) such as one month and be refreshed weekly. Following the initial matching of talent to school and prediction of future AQC needs, there may be a process of receiving feedback by the recruiters and business consultants as well as direct feedback data input to the rules/mathematical model for future improved performance including, potentially, a more satisfied client school and decrease in teacher absenteeism. There may be provided as an adjunct to both the AQC and client school a GPS monitor of the status of a given AQC as they prepare and travel to the school. Adjunct apparatus may include the GPS program used by a typical hand-held telecommunications device a time of day and date clock that may remind the AQC or client school of the path from AQC home to school, date and start time and a camera which may produce images of AQC appearance for recruiter or client school critique. FIG. 1 represents collection of data from a client school and from candidates, and FIG. 2 may represent a system comprising a server search manager 220 at an employment agency, a related set of databases 200 and a plurality of client/school input devices 230 for inputting job orders and feedback and candidates 205 representing application data entry on line or collected during a candidate interview fed to the search manager 220 following rules/mathematical model 350 to identify a pool of available qualified candidates represented by a specific client school part of the Candidate/client school databases 200. Search manager 220 and search engines 210 must operate at all levels from infant/toddler teaching assistant at a client school to a most advanced placement physics school teacher level. The search manager 220 may comprise a plurality of search engines 210(1) through 210(n) to verify initial data (such as education and experience level of a candidate) and to build a particular AQC/client school database of a set of such databases 200 to fill a particular, job order of a particular client school.

Referring first to FIG. 1, there is shown a well-known Venn diagram intended to exemplify a matching process of a client school job order placed according to FIG. 6A through FIG. 6J to a pool of varying candidates for teaching positions (from toddler/infant age) to a need for an advanced placement physics instructor entered by the client school application downloaded to a client hand-held device such as a cell phone used by a school, administrator at a client school, the client school having a varying degree of restrictiveness as to, for example, appearance code.

FIG. 2 is a schematic block diagram of the hardware relationships between a plurality of candidates, a plurality of client schools and a plurality of search engines for each level of candidate and grade/course of client school for utilizing rules and mathematical models as described herein for verifying data stored in databases 200 via search engines 210 to automatically correct input data (for example, school profile data or disqualify a candidate whose educational background cannot be substantiated) initially stored in databases 200 and accomplish a match between a qualified candidate and a client school. FIG. 2 shows a plurality of client schools 230(1) through 230(m) who may, via their administrator or other person having a functional duty to obtain a particular substitute teacher for a particular day. They may use a hand-held device to identify themselves and their location with a user name and password and then proceed to enter data required for completing a substitute teacher or aide job order. A search manager 220 may initially load a set of candidate/client school databases 200 with data entered by a candidate substitute teacher, an interviewer per FIG. 3 and by a client school such that a search engine 210(1) through 210(n) may follow the steps of FIG. 3 to identify a pool of available qualified candidates for filling job orders confirmed by client schools. Data submitted by either candidates in the application and interview process or client schools at step 345 as a client school profile (possibly with the assistance of a business consultant (BC) of FIG. 3) may be verified automatically by search engines 210(1) through 210(n) and any error uncovered where, for example, the educational background of a candidate is not verified by the colleges/universities allegedly attended by the candidate may result in the disqualification of the candidate. Similarly, if a client school indicates that, for example, classroom supplies, textbooks and funding for extracurricular or scheduled activities is not made available by the client school and becomes a burden on a substitute teacher, the client school may be asked to explain the funding process and assure that funding for school activities is not the responsibility of the substitute teacher. Search engines 210(1) through 210(n) may be specialized; for example, the K in search engine 210(1) may represent kindergarten or pre-kindergarten or toddler and the search engine 210(n) may represent a specialized search engine to verify credentials of a potential advanced placement physics teacher. Other search engines 210 may be for elementary school grades 1-6 or for middle school or other positions such as a teaching assistant or aide.

FIG. 3 provides a flowchart/database for collecting data starting with the process followed by a client school to complete a substitute teacher or aide job order and predict client school needs per FIG. 4. Typically, the school administrator may use a mobile device 305 and follow a plurality of screens once a staffing agency is connected. The mobile and or requester such as a school administrator 315 may receive and provide data to the process request box 310. Job order application data may be automatically gathered, for example, location data for the administrator/requestor (such as school location) may be collected via a global positioning feature of the mobile device. The time and date of the request may be collected by a real time date and clock feature of the mobile device. In processing the request or job order, there may be a matching attributes process such as matching of administrator to location data for a given school to be sure the administrator and the specific client school needing the substitute are separately identified but matched as well as a geographic matching of AQC's to a job order for a GPS located client school location. A business consultant (BC) may evaluate each client school and school location which process may be less structured than that used by a recruiter of a substitute teacher candidate (which may involve, for example, criminal background checks, drug use and medical data). The business consultant is interested in collecting data about the client school and related school system if it comprises more than one school location to determine similarities and dissimilarities of related schools such as private and charter schools so that assumptions are not made about one client school versus another client school of the same type.

At the upper right of FIG. 3 is a candidate process which may include the uploading of an application (not shown) showing name, date, desired positions, experience, education and the like. The process is most concerned with a one-on-one interview with a job recruiter shown as box 320 which provides input as to a candidate for a teaching or aide position. The analysis for acceptance 325 of an available qualified candidate 325 may be made via the use of a questionnaire useful to the recruiter to be sure the recruiter has thoroughly evaluated a number of categories of the candidate. The categories include Appearance—Clothing fits, neat, jacket with no tie or tie with no jacket or both coat and tie. A second category is Intellect which is an articulation of education and teaching experiences. The candidate should exhibit knowledge subject matter, use proper pronunciation and articulate so that the candidate demonstrates that the candidate will be heard by students and understood. A third category is Presentation/Personality which are exhibited by making eye contact with the recruiter at the interview, using body language to advantage (without displaying a negative attitude), speaking with hands, proper volume of speech to be heard, not speaking so quickly or speaking with an easy to understand speed, pitch and rhythm. This is especially true in teaching a foreign language which may, for example, be teaching English to Spanish speakers or other foreign languages (Latin being an exception since it is not known how the Romans spoke).

The SMRT process expands the subjective process to incorporate further categories including: Awareness where potential talent realizes that, their attire may not match the setting they may be placed in. The candidate is able to articulate what attire is appropriate for the particular environment the candidate may find themselves in for a restrictive dress code such as coat and tie versus what attire is incongruent with the dress code and culture of the client at a given level (infant or senior in high school). Setting match is matching candidate to setting. A candidate should be aware and have the ability and willingness to take steps to modify their appearance (clothing) to fit the apparent dress code used by peer teachers or aides at the client, school at their level of substitution and client culture (for example, they may bring extra clothes such as a tie for a coat or extra shoes such as tie shoes versus loafers or tennis shoes. The candidate may always discuss their appearance by using a camera of their cell phone and by sending a selfie of themselves dressed for the client school level to their recruiter or to the client school and obtain advice or help.

A mathematical rating system or mathematical model comprises a number of rating steps which may vary with the client school and level of teaching. For example, each candidate may start with three points by showing up at a recruiter interview. An award of three points indicates that the recruiter has found that the candidate's appearance is appropriate for a recruiter interview, for example, may involve checking a candidate for their choice of interview apparel such as coat and tie versus T shirt, sloppy cut-off jeans and tennis shoes.

The following attributes may add or subtract from the original three point score given a candidate for appearing at an interview: (A) clothing does not fit −0.5; success in other organizations with similar settings +1.0; success in other organizations with different cultures, for example, church, political groups or full-time employment positions +1.0; smell, odor from breath or inappropriate choices for an interview −2.0; observation of intoxication −3.0; and inappropriate clothing for an interview −1.0. (B) If dressed inappropriately at an interview, the candidate may be prompted that they need to correct their appearance −1.0; or, on the other hand, if there is inappropriate dress, the candidate recognizes that they have done so and no prompting is needed to correct −0.5; if the candidate provides acceptable answers to “What if?” questions such as finding themselves in a different culture than expected with, respect to clothing then +1.0.

Tier level is applied to a client school setting from prekindergarten or infants level to a high, school level and curriculum. High scoring talent can be placed anywhere up to the highest level minimum score accepted by a client school at a given level and Tier. No candidate with a score below 1.4 may be placed at a client school. A Tier level relates to the level identified by a business consultant for a given client school at a given level from infant to high school. Tier level 1 relates, to least restrictive, Tier 2 relates to average restrictive and Tier 3 relates to most restrictive. Tier 1 requires at least a score of 1.5 as a lowest possible candidate score; Tier 2 a minimum score of 2.0, and Tier 3 requires a minimum score of 2.8.

A further category is Intellect for a candidate. Intellect is Knowledge of the subject matter at the given level of substitute level required from infant to high school level, proper pronunciation, especially in the language arts and proper articulation at the level such as articulation of mathematical concepts such as algebra equation solving or geometric proofs. In Intellect, (A) is Knowledge of the subject matter to be taught such as kindergarten, third grade, middle school, a first, second or third year of French or calculus or differential equations. Does the prospective talent or candidate have on the job experience teaching a given, subject or dealing with infants or toddlers? If no experience, then, the score is 1 and if yes, the score is 3. (B) is Pronunciation and articulation—can the candidate share/communicate a thought clearly? The scoring is −2 for no and +3 for yes. An example might be the concept in French that certain verbs use “etre” for the past tense while others require “avoir.” The candidate may have to memorize these differences in spoken French. No scores below 0.5 may be placed with a client school for a given position. The scores may be added from above from both (A) and (B) and divided by two (averaged or otherwise weighted). In these categories, the lowest acceptable score is 0.5 for Tier 1—least restrictive schools; 1.0 for Tier 2 or average restrictive client school, position and 3.0 for Tier 3—most restrictive client school position.

A further category of scoring is Presentation. This factor is an observation of the talent based on the interview interaction that takes place between a recruiter and a candidate. After the candidate is settled and made to feel comfortable by the recruiter, the interview may begin. After the interview, the recruiter will determine the overall impression made by the candidate/presentation of knowledge or Intellect for a given level or position demonstrated by the candidate. Below are the following traits to consider by a recruiter—not all candidates start with three points: Formal +0.5; Familiar +1.0; Pleasant +1.0. On the negative side, Forward −0.5; Pushy −0.5; appears inconvenienced by the interview −2.0; demonstrates an Agitated attitude −1.0 and, if there are mitigating circumstances to any of the above factors, the candidate may earn +1.0. The scores required for the presentation category range from greater than or equal to 2.0 for Tiers 1 and 2 and greater than or equal to 4 if Tier 3—most restrictive.

Now the category of conflict maturity will be discussed. Several of the instructors in schools today have experienced conflict with adults (peers who may resent their presence) or the administrator of the school or teaching aides. There also may be conflicts with students or between students and conflict maturity is the ability to handle conflicts such as the above occurring on any given day. Some candidates excel in a conflict environment and some do not. Hypotheticals may be used by the recruiter to draw out the candidate to evaluate conflict maturity. What if you enter a classroom and the class will not quiet themselves so that the candidate may be heard? Conflict maturity and acceptance that conflict may occur is rated by a Y for yes and an N for no. Later, when a candidate is placed, conflict maturity may be judged by candidate performance at a client school with positive or negative feedback provided by the client school.

A category for further scoring a candidate is their Temperament. Good temperament is a plus for both the candidate and the client school to be able to match a general disposition of a positive attitude. Each individual falls into one of these categories of Temperament. The recruiter may allow the candidate to self-evaluate: A) Sanguine—Optimistic/positive, especially in an apparently bad or difficult situation; B) Melancholic—Suffering from or denoting a severe form of depression—the opposite of a positive attitude; C) Choleric—bad tempered or irritable in front of the students and D) Phlegmatic—the candidate stays calm even when upsetting or exciting things happen; candidate may be perceived as calm or unemotional in times of stress; stolid or showing little emotion. The recruiter should not hire B or C.

The following is a summation of overall scoring: Tier 1—a least restrictive client school at a given level—lowest possible score accepted 4AY, 4AN, 4DY and 4DN. For Tier 2, average restrictive, 5AY, 5AN, 5DY and 5DN. For most restrictive Tier 3, the scoring is 7.8AY, 7.8AN, 7.8DY and 7.8DN.

The aspects, advantages and/or other features of example embodiments of the invention will become apparent in view of the following detailed description, taken in conjunction with the accompanying drawings. It should be apparent to those skilled in the art that the described embodiments of the present invention provided herein are merely exemplary and illustrative and not limiting. Numerous embodiments of modifications thereof are contemplated as falling within the scope of the present invention and equivalents thereto. Any publications, patent applications, patents, and other references mentioned herein are incorporated by reference in their entirety.

Now, some comments are appropriate about available qualified candidates and client schools. The matrix used by a typical recruiter at an employment agency is arbitrary and is based on a hope for candidate growth. As a result, there is a continuing imbalance between the needs of the schools and the available talent. Referring to FIG. 4, agencies may solve their problems with an automated predictor of AQC's; otherwise, schools must scramble to hire additional staffing agencies to fill unmet needs, and talent is not engaged/hired because there are not enough positions. Either real or not, the perception remaining with the client schools may be that the staffing firm is not an honest broker by either the talent (the candidates) or the client school.

FIG. 4 shows a periodic predictive AQC (for example, weekly) process at the client school level to determine the potential of talent needed during a year with the month of July 2018 as an example. Use of the AQC predictor feature facilitates an honest discussion between the school and the candidate via the agency regarding the availability of talent based on a forecasted AQC pool. The AQC also informs the recruiter that additional talent is needed or the client pool needs to be increased, for example, during a feedback opportunity to the agency. FIG. 4 is an exemplary chart for the month of July, 2018 of certain AQC results of prediction for the month. Weighted performance 410 is the percent of activity in a given month. SMRT Talent Placed 415 is a number of substitute teacher or aide placements on each given day in July. A Pool Placement Goal 420 may be 90% of the Job Orders received from client schools. It is estimated that each temp (selected candidate) may have two to three job orders (JO's) each week. Also, we expect a 60% Fall-off rate from week to week. The Replacement target is, for example, twelve Temps per week placed. Job Orders (JO's) 430 are the orders coming in from the client schools at all levels. We expect a 90% fulfillment rate of all JO's from the AQC pool of talent. Finally, Pool Size 435 is the estimated number of candidates available for placement at the end of each week. Summary 450 is a forecasted summary of July performance for one or more schools as forecast via the flowchart of FIG. 3.

For example, for July 2, the starting pool size may be 50, the minimum monthly is 46 less the monthly fall-off predicted at 60% of the starting pool or 30 leaves, at month end or July 26, a month end pool size of 66. If starting JO's are at 55 on July 2, given a 10% JO increase (of about 5) that leaves 61 and given the month end pool size of −66 leaves a deficit of −7. Excess candidates can give a bad reputation because the impression that recruiters are misinforming the candidates concerning placements must either increase sells or provided permanent placement with client schools at the end of the month.

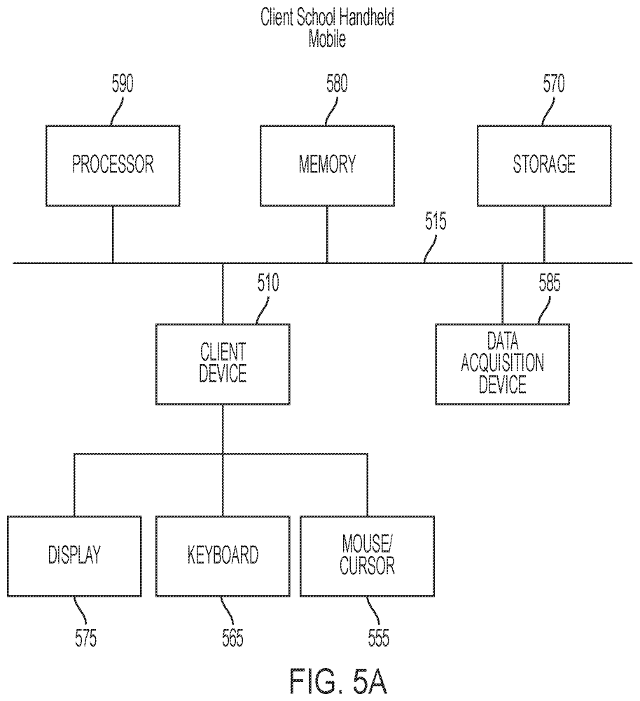

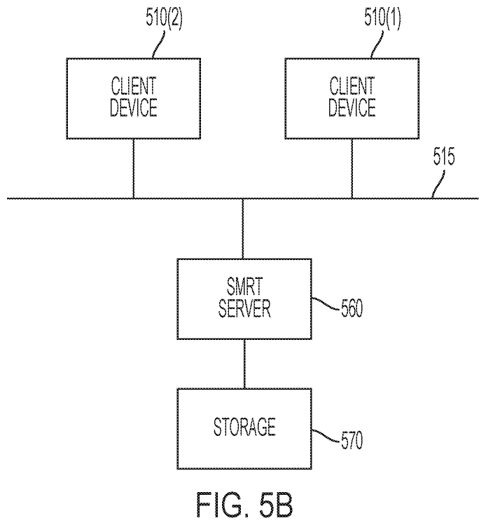

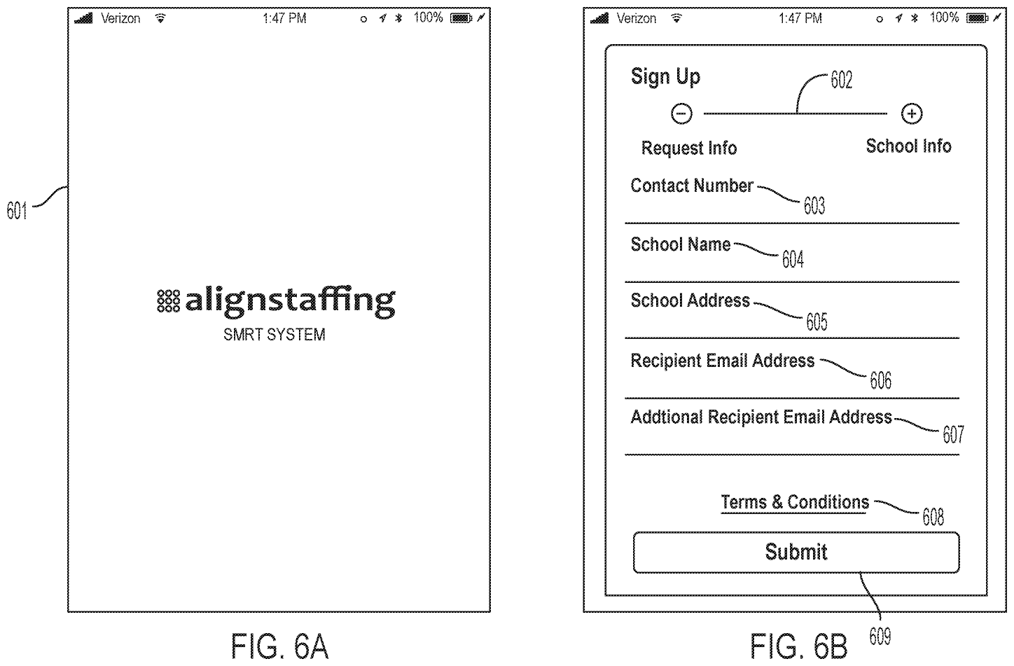

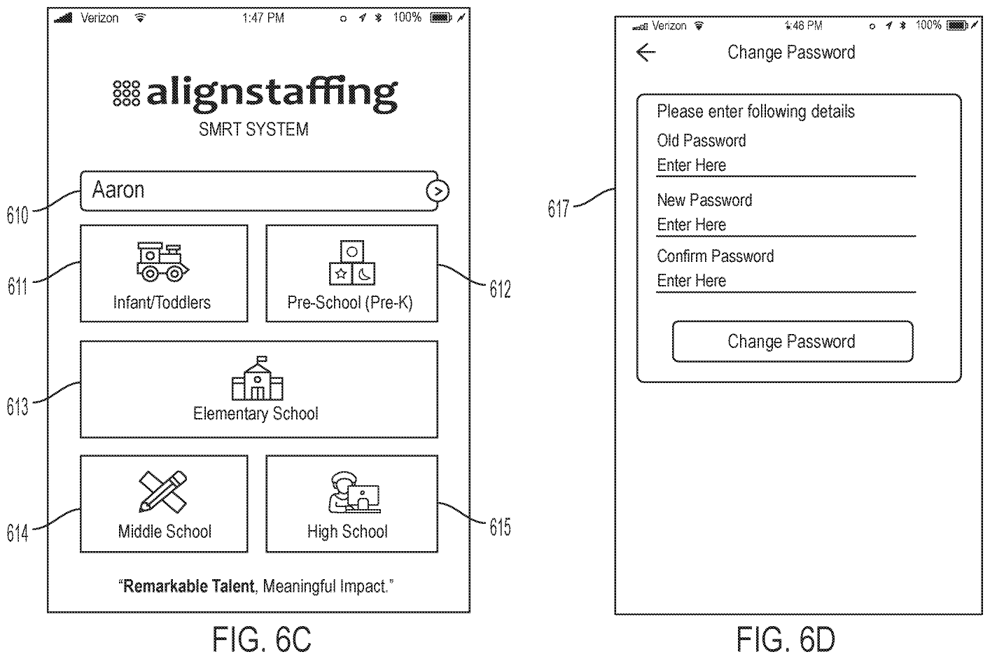

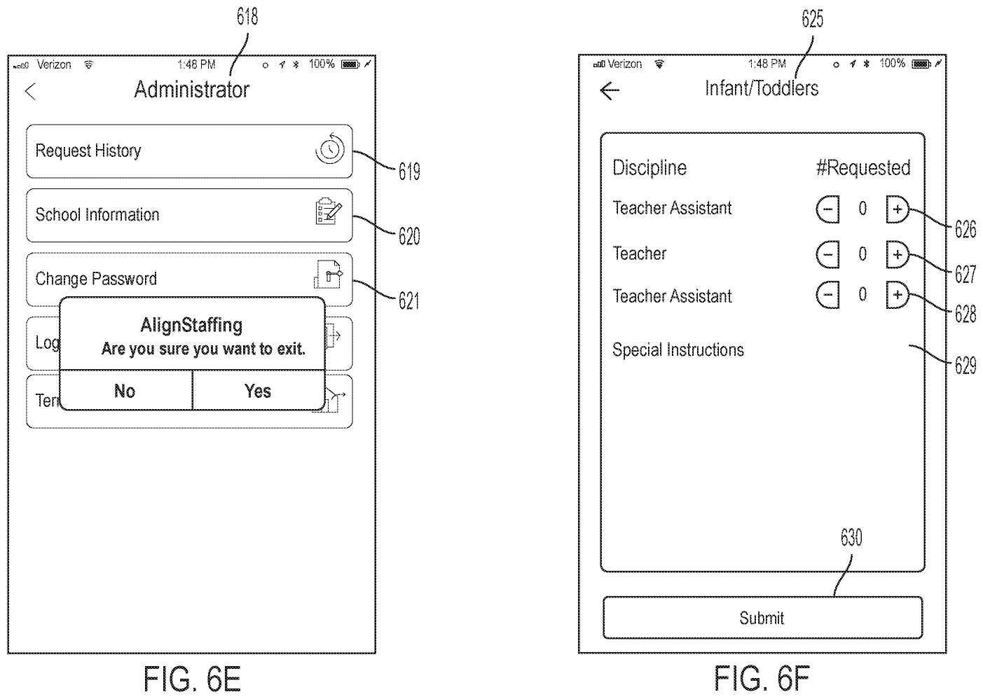

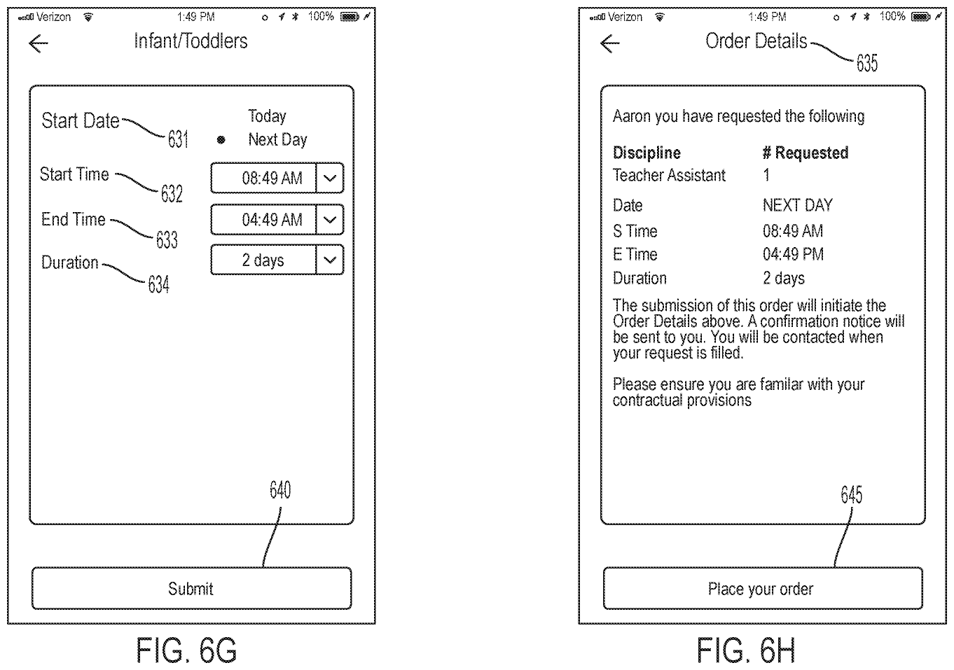

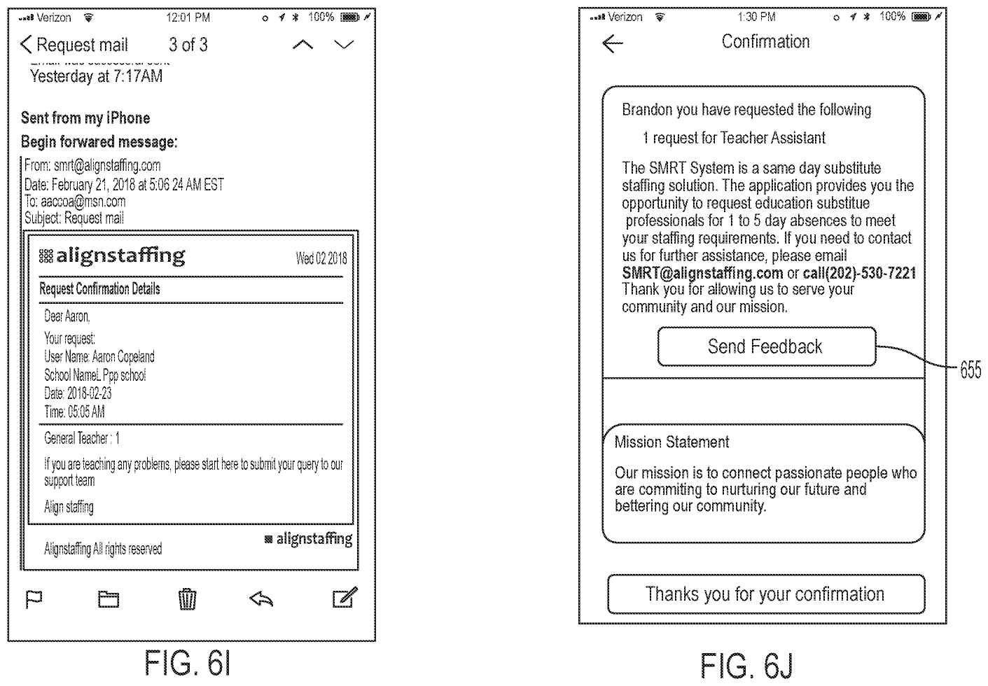

Referring to FIG. 5A and FIG. 5B, there is shown a data modeler platform in accordance with one embodiment for use on a client school handheld mobile device for producing screen shots and collecting client school data. In accordance with FIGS. 5A and 5B, client 510, 510(1) or 510(2), search server 560 and storage 570 can be combined as a single unit (e.g., mobile device, a computer or laptop), or separate units (multiple computers or devices that communicate using, for example, a network). Each unit is able to communicate with either a client school user (using, for example, a keyboard 565, mouse/cursor 555, and display 575) or a computer or device (using, for example, a wired network such as the Ethernet or a wireless communications infrastructure such as an IEEE 802.11 or a packet data network such as a 3G cellular or PCS), which can optionally provide an interface to a school client user.

The SMRT server 560 (FIG. 5B) typically located at the employment agency entity may be implemented using several networked servers with different functions allocated to each server; (see FIG. 2). For example, a server 560 might be utilized for each database index. Examples of such indices may be location, education level, experience at a grade level, medical history, criminal record, drug use and the like. A separate server, or multiple servers, not shown, might also be utilized to process transactions and communications with client schools. One or more servers 560 might be utilized to control specialized data or image acquisition equipment such as cameras, global positioning systems and real time of day and calendar year programs (client devices 510, 510-1 attached via bus 515. Alternatively, some or all of these servers 560 might be implemented as virtual servers in one or more physical servers using software such as Xen (http://www.xen.org/), VMware ESXi (http://www.vmware.com/), or Sun xVM Ops Center (http://www.sun.com/software/products/xvmopscenter/index.jsp).

As another alternative, the server 560 of FIG. 5B could utilize a computer with multiple processors and/or multiple cores having either a symmetric multi-processing (SMP) or non-uniform memory access (NUMA) architecture. Storage 570 and memory 580 (FIG. 5A) may be relegated to a cloud network or can be contained within the server 560 or mobile device (FIG. 5A), or separate, as would be the case, for example, when a network-attached storage (NAS) device or storage appliance was used. Redundant storage systems may be utilized; example technologies include RAID and Sun ZFS, and may include redundant hardware, power, and network pathways. The SMRT server 560 may, by way of example, be a Sun Fire X2200 M2 x64 Server containing two quad-core AMD model 2376 processors, 32 GB of memory 580, two 146 GB SAS hard disk drives, and a DVD-ROM. The bus system 515 may include a Sun StorageTek™8-port external SAS PCI-Express Host Bus Adapter that is housed with the server 560 as an interface to an internal or external storage array 570. The external storage array 570 may be a Sun Storage J4200 array with 6 TB of storage or simply a thumb drive. A network switch for a network of servers is not shown but may be implied from their common utility in, for example, a local area network, a wide area local network or any telecommunications network known in the art. A typical network switch for the system of FIG. 5B may be the Netgear JGS524 Prosafe 24-Port Gigabit Ethernet Switch, with compatible (CAT-5e or CAT-6) cabling. If one were to use network attached storage (NAS) such as iSCSI or a network storage device such as the Sun 7200 Unified Storage System, a second network switch might be utilized to separate data traffic between the storage system 570 and the server 560 from data traffic between the server 560 and other computers or clients 510.

System components will now be discussed with reference to FIG. 5A. Referring to

FIG. 5A, the system supporting databases and prediction of required AQC's has at least, one processor 590, but may have more than one processor, and the processor may implement more than one processor core. The processor has access to memory 580, which is used to store index structures such as AQC and client school data that enable rapid access to stored objects that have similarities to the attributes of a target object specified in a query for a match between client school and AQC. Storage 570 is utilized to provide persistent memory and to serve as a repository for information that does not need to be accessed as efficiently (rapidly) as the in-memory objects. For example, images from a camera may reside in storage 570 while descriptions of the client schools, levels and positions available or other attributes may reside in memory 580. One or more clients 510 can submit queries to the server's software for a match between AQC and client school at a given level, which are interpreted by the processor 590 in order to perform searches using the index structures that are resident in memory 580 and, possibly, the data contained in the storage 570. Results are returned by the processor 590 to the clients 520 via a network (not shown). Users can interact with the system through the client(s) 510 using input devices such as a keyboard 565 (virtual keyboard) and mouse/cursor 555 and output devices such as a display 575. All of the components may be implemented in a single computer system such, as a mobile device, laptop, desktop, or server, or they may be implemented in separate computers that interact using a communications medium such as a wired or wireless network. A candidate may interact with a recruiter in a similar way as a client school may interact with a search server of an employment agency.

A data acquisition device 585 such as a camera a global positioning system and a real time clock and day calendar may be connected to either a client 510 (such as a mobile device) or a server 560 using an interface such as a serial interface, Ethernet, a data acquisition and control card, a universal serial bus (USB), or a FireWire bus or network. Example data acquisition devices include scanners (for example, for a class syllabus upload by a client, school), cameras (still image or video), antennas, sensors such as odor or acoustic sensors, and laser rangefinders or other scanners (not shown). The interface to the data acquisition device 585 may be bi-directional, meaning that the server or client can control, the operation of the data acquisition device 585 to, for example, locate an AQC on their way to a client school on their first day filling a job order. The data acquisition device 585 may utilize a wireless, wired, acoustic, or optical communications link to control a remote device and/or acquire information from a remote device.

Now the client school application downloadable to a hand-held device (such as a mobile phone) or a personal computer will be described via exemplary screen shots FIG. 6A through FIG. 6J. FIG. 6A is an introductory screen for a placement service using the present invention. FIG. 6B has a sign-up bar which may show how long in the process the client school has progressed from an initial request through submitting school information 602. In vertical sequence, in any order, there are requested entry contact number 603, for example, e-mail and/or telephone; school name 604; client school address where talent is needed 605; the receipt e-mail address 606 may be hidden; an alternate receipt e-mail address may be provided 607 for identity of an AQC. Terms and conditions may be read by clicking the highlight and checking the box 608. Once the information is completed, the administrator or other school representative clicks the submit button 609.

FIG. 6C represents the SMRT System for entry of a particular level of substitute teacher level requested front Infant/Toddlers 611 to Pre-School or Pre-K 612 to elementary school 613 assuming Kindergarten included, middle school level 614 and high school level 615.

FIG. 6D represents a typical screen useful for entry or change of a password 617 so that the administrator or other representative of the client school may obtain access to the status of their request.

FIG. 6E is titled Administrator 618 where the Administrator may click “request history” 619; school information 620; go to the change password screen 621 FIG. 6D, and asks if one is sure one wants to exit after clicking on one or more of the choices 619-621.

FIG. 6F represents the level of infants and toddlers 625, and a client school may request teaching assistant 626, teacher 627, and Teacher Assistant 628, Special instruction 629 with a submit button at the bottom 630.

FIGS. 6G through 6H are for either submitting or placing a job order where 631 may be a start date selected as next day or today, starting at time 8:49 AM 632 and ending at end time 633 4:49 PM for a duration of two days 634. The job order details 635 may be confirmed on FIG. 6H where button place your order 645 places the order for an infant/toddler teacher for two days beginning the next day. An example of job order details is Discipline: Teacher Assistant, Date, next day; Start time 8:49 AM, end time 4:49 PM and Duration 2 days. Further instructions may be: “The submission of this order will initiate the Order Details above. A confirmation notice will be sent to you. You will be contacted when your request is filled. Please be sure you are familiar with your contractual provisions.”

FIGS. 6I and 6J are alternate ways of communicating a confirmed order by mail (Request mail) FIG. 6I or by confirmation screen (FIG. 6J). The confirmation screen of FIG. 6J permits feedback 655 to be given to the staffing agency for, for example, modifying certain parameters entered such as dress code and the like or required talents of the substitute. Aaron when used in a slide represents either a name or a location of Aaron or the client school needing the substitute.

As explained above, certain features of a cell phone may be utilized by any of a client school, an AQC and a representative of the agency as follows, a global positioning feature may be used for providing directions or locations of an AQC at a particular time, a camera may be used to capture a self-picture of a candidate to obtain advice on dress code and a real time clock and date may alert the candidate of the start date and time and continue to advise if a longer assignment of AQC is required.

In describing, example embodiments, specific terminology is employed for the sake of clarity. However, the embodiments are not intended to be limited to this specific terminology.

As used herein, “a” or “an” may mean one or more. As used herein, “another” may mean at least a second, third, fourth or more and so on. Furthermore, unless otherwise required by context, singular terms include pluralities and plural terms include the singular.

Although the invention has been described in example embodiments and a method of matching AQC's and client schools disclosed, additional modifications and variations would be apparent to those skilled in the art. It is therefore to be understood that the inventions herein may be practiced other than as specifically described, for example with respect to the rules assumed, the mathematical model used for a given AQC evaluation, the tier definition for a client school, the feedback data and related processes, the features useful and provided by a typical candidate mobile device and display screen, etc. Thus, the present embodiments should be considered in all respects as illustrative and not restrictive. Accordingly, it is intended that such changes and modifications fall within the present invention as defined by the claims appended hereto.

What we claim is:

1. Apparatus comprising, a mobile device having a display, a data acquisition device, a virtual keyboard and a processor with memory for communicating with a search manager server for making a match between an available qualified candidate and a client school for a substitute teaching position,
the display screens for use by a client school for entry of profile data about the client school and job order data about a desired candidate position including location of the client school and available substitute teaching position,
the processor for predicting availability of available qualified candidates in accordance with a rules/mathematical model comprising a plurality of categories, the categories comprising appearance, intellect, presentation/personality, conflict maturity, temperament and a model for scoring these for comparison with a tier level of restrictiveness of a client school between one and three whereby an available qualified candidate is timely presented to a client school as a candidate for a substitute teaching position at a requested level between infants/toddlers and high school,
the client school providing feedback to the employment agency for reducing a typical number of absentee teacher days during a school year below eleven.

2. The apparatus of claim 1 wherein the data acquisition device comprises a global positioning system of the mobile device for determining one of the present location of the available qualified candidate and the client school.

3. The apparatus of claim 1 wherein the data acquisition device comprises a camera for providing an image of an available qualified candidate to the client school for matching with a dress code.

4. The apparatus of claim 2 wherein the data acquisition device comprises a real time clock and calendar day program for advising the current time and whereabouts of the available qualified candidate while the candidate travels at an appointed time to the client school.

5. The apparatus of claim 1 further comprising a plurality of search engines connected to the search server, the search server compiling a set of candidate/client school databases for each client school, the plurality of search engines for automatically verifying candidate data stored in the set of candidate/client school databases via one of a candidate mobile device and during a candidate interview and for verifying client school data received as a client school profile.

6. The apparatus of claim 1, the processor for receiving feedback from one of the candidate placed at a client school and the client school, feedback data being utilized by the processor for modifying, parameters of the rules/mathematical model for a client school.

7. A method of matching a plurality of candidates to a client school profile and job order for a substitute teaching position, the method comprising:
collecting and storing candidate data in a set of databases comprising a candidate/client school database for each client school,
automatically verifying via a plurality of search engines controlled by a search manager server the collected and stored candidate data, and
excluding a candidate for filling a job order for a substitute teaching position; a search manager verifying candidate data indicating that a candidate has misrepresented one of their educational background and their experience level.
